(19) United States
(12) Patent Application Publication
(10) Pub. No.: US 2005/0197117 A1
(43) Pub. Date: Sep. 8, 2005

(54) System for exchanging a provider point information into a host point information

(76) Inventor: Kazumitsu Matsuura, Los Angeles, CA (US)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/784,264

(22) Filed: Feb. 24, 2004

(51) Int. Cl. G06F 17/60; H04Q 7/20

(52) U.S. Cl. 455/432.3; 705/14

(57) ABSTRACT

There is provided a system for exchanging a provider point information into a host point information. The system comprises a host equipment, having (i) a host memory for memorizing a host account in connection with a host account holder information and a host point information including available host points, and (ii) a host controller for controlling the host memory. The system also has a provider equipment connected to the host equipment, comprising: (i) a provider memory for memorizing a provider account in connection with a provider account holder information and a provider point information including available provider points, and (ii) a provider controller for controlling the provider memory. The system also has an account holder terminal connected to the host equipment, comprising: (i) a display for browsing the host point information including the available host points, and the provider point information including the available provider points, and (ii) a data inputting device to designate a portion of the available provider points of the provider point information.

### FIELD OF THE INVENTION

The present invention relates to a system for exchanging a provider point information into a host point information. More particular, the present invention relates to an invention to exchange various kinds of points issued by various companies into a standardized point.

### DESCRIPTION OF THE INVENTION

Recently, there increase companies who provide points to customers depending on the amount or frequency of their purchases and utilizations. Generally, each company opens an account to a customer, that is, an account holder, to keep and maintain the points. The customers are interested in the points since they award an attractive gift when reaching a specific amount. The awards may include free air tickets, free travels, free gifts and so on. Since the points promote the customers to continuously choose a company, it may be a good idea to keep the customers. However, the specific amount of the points may be set to be high to receive an attractive goods or service. Many customers have points not reaching the specific amount. Presently, such insufficient points is useless, and kept to be in a drawer.

For example, an air line company A provides mileage program A and an air line company B provides mileage program B, both issuing customer cards to accumulate their own points. Both of the mileage programs give points to a customer in accordance with his or her boarding times and traveling mileage. Each of the mileage programs gives an award, such as a free air ticket or gift, at the time when the mileage points reach a specific amount (for example, 20000 miles). The specific amount to give an award is respectively defined by the companies. A customer sometimes participates in both of the mileage programs A and B, but points of each programs are insufficient to receive an award. However, there often may be a case where provided that the points of his or her mileage program A is added to the points of his or her mileage program B, the sum of the points is sufficient to receive an award. In such case, the customer wishes to do that, but currently there is no system to do so.

Though the points of a company are useless unless they reach a specific amount, the points should be valuable since the points are usually deposited to his or her account in exchange of purchases of products or utilizations, while attracting the customers for an award. Therefore, it has been demanded to standardize the various kinds of points issued by various companies.

### SUMMARY OF THE INVENTION

The inventor of the present invention has studied to exchange the various kinds of points into a standardized point. According to the present invention, there is provided a system for exchanging a provider point information into a host point information. The system comprises a host equipment. The host equipment comprises (i) a host memory for memorizing a host account in connection with a host account holder information and a host point information including available host points, and (ii) a host controller for controlling the host memory.

The system also has a provider equipment connected to the host equipment. The provider equipment comprises (i) a provider memory for memorizing a provider account in connection with a provider account holder information and a provider point information including available provider points, and (ii) a provider controller for controlling the provider memory.

The system also has an account holder terminal connected to the host equipment. The account holder terminal is provided to an account holder having the host account and the provider account. The account holder comprises (i) a display for browsing the host point information including the available host points, and the provider point information including the available provider points; and (ii) a data inputting device to designate a portion of the available provider points of the provider point information. The designated portion of the available provider points of the provider point information is sent to the host controller of the host equipment and exchanged into host points in connection with the host point information. The host points exchanged is added into the available host points memorized in the host memory.

The host controller may exchange the provider points into the host points in accordance with a ratio determined in connection with a market principle.

The host controller may exchange the provider points into the host points in accordance with a ratio determined by the following formula: (the ratio)=A*B*C, where “A” represents an original rate, “B” represents a marketing rate, and “C” represents a currency rate.

The host controller reversely exchanges the host points into the provider points. A portion of the available host points of the host point information is designated and exchanged into the provider points in connection with the provider point information. The provider points exchanged is added into a kind of the available provider points, which is selected by the account holder, memorized in the provider memory.

The system of the present invention may includes a shopping equipment displaying an article or service. The account holder designates the article or service in exchange of a portion of the available host points.

### BRIEF EXPLANATION OF DRAWINGS

FIG. 1 shows a diagram showing a system of the present invention.

FIG. 2 shows an illustrative view of the host equipment of the present invention.

FIG. 3 shows an illustrative view of the content memorized in the host memory of the present invention.

FIG. 4 shows an illustrative view of the content of the host point information memorized in the host memory of the present invention.

FIG. 5 shows an illustrative view of the provider equipment of the present invention.

FIG. 6 shows an illustrative view of the content memorized in the provider memory of the present invention.

FIG. 7 shows an illustrative view of the content of the provider point information memorized in the provider memory of the present invention.

FIG. 8 shows an illustrative view of the account holder terminal of the present invention.

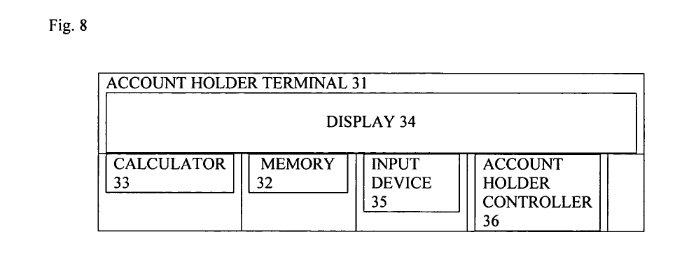

### DETAILED EXPLANATION OF THE INVENTION

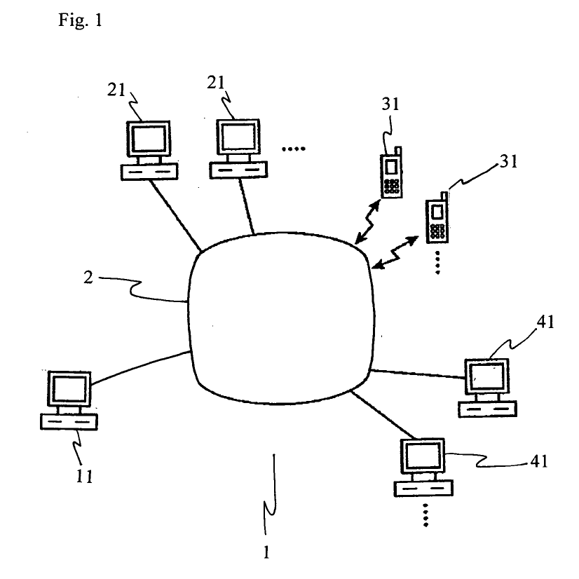

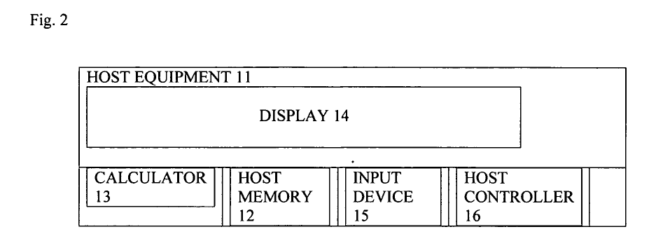

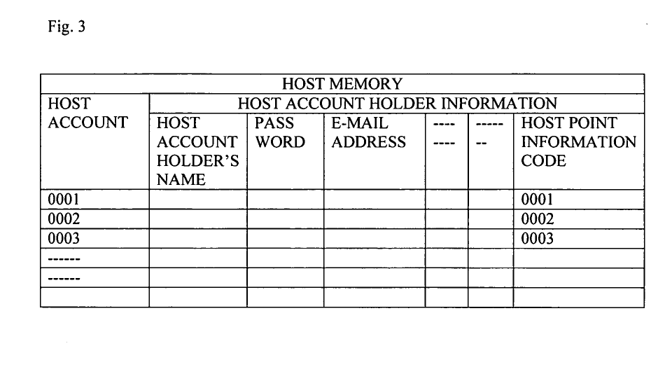

FIG. 1 shows an illustrative view of the system 1 of the present invention. The system of the present invention has a host equipment 11. The host equipment 11 is usually located in a host company. The host equipment 11 is connected to provider equipments 21, account holder terminals 31, and shopping equipments 41, via internet or telephone lines 2. The host equipment 11 has at least a host memory 12, calculator 13 (host controller, CPU), display 14, inputting device 15 and host controller 16, as shown in FIG. 2. The host controller includes an algorithm or software to control the host equipment. The host memory 12 memorizes a host account in connection with a host account holder information, as shown in FIG. 3. The host account means an account opened in the host equipment or opened by the host company. The host account holder information memorized in the host memory includes the information for identifying account holders, such as host account holder's name, password, login name. address, telephone number, facsimile number, e-mail address, sex, date of birth, work field, family number, marriage status, and hobbies of the account holder. These information are usually registered in the host memory when an account holder opens a host account in the host equipment. The host point information is also memorized in connection with host point information code in connection with the host account, as shown in FIGS. 2 and 3. The host point information includes the information as to host points, such as, available host points, latest access date, provider information and so on. The host controller 16 in the host equipment 11 controls reading and rewriting the information in the host memory.

In detail, when a person sends a login name and a password to the host equipment, the host equipment refers them to the host point information memorized as the password and login name. If both of the login name and password sent by the person correspond to those memorized in the host memory, the host equipment 11 recognizes the person as a host account holder, allowing him or her to access its host account. On the other hand, if either of the login name and the password does not match those memorized in the host account, the host equipment 11 declines the person to access any host account, and alternatively showing a page to ask the person if he or she forgets the password or login name. If the person selects a key to remind him or her of the password and login name, a new page having a box is opened for entering his or her e-mail address in the box. When entering an e-mail address and pushing a send button, the host equipment 11 refers to the list of the e-mail addresses memorized in the host memory 12. If the e-mail address is found in the host memory, the host equipment sends back the registered password and login name in connection with the e-mail address, to the registered e-mail address. If the e-mail address is not found in the list of the e-mail-addresses, the host equipment 11 declines to send any information memorized in the host memory, and alternatively, asks the person to open a new host account in the host equipment 11.

The system 1 of the present invention has a provider equipment 21. The provider equipments 21 are connected to the host equipment 1 1, via internet or telephone lines 2. Each of the provider equipment 21 is usually located in a provider. In this application, a provider means a body to provide points to consumers. The points of a provider are provided in accordance with a provision ruled by the provider. The provider includes any business entities such as airline companies, hotels, shops, restaurants, credit card companies, communication companies, insurance companies, website providers, and so on. The field of the business entity does not limited in the present invention, so long as it provide any points in accordance with purchases from or utilization of the company. Conventionally, each of the companies or providers issues their own customer cards, on which points are deposited to the customers to keep the customer as a client. Usually, the points are provided in proportion to the amount of purchases and utilizations. For clarity, two providers are shown in FIG. 1, but the number of the providers are not limited.

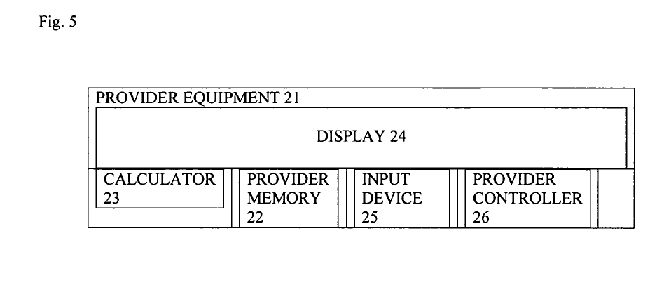

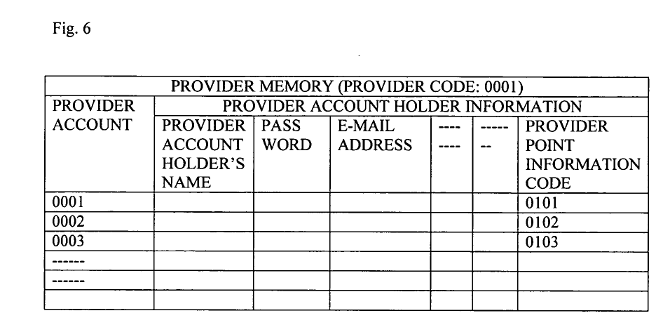

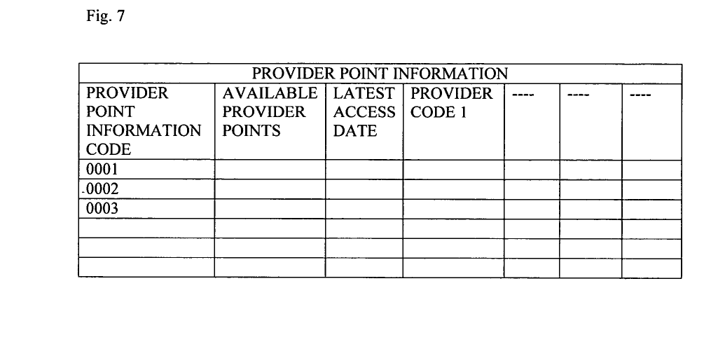

The provider equipment 11 comprises at least a provider memory 22, calculator (provider controller, CPU) 23, display 24, inputting device 25 and provider controller 26, as shown in FIG. 5. The provider memory 22 memorizes a provider account in connection with a provider account holder information. The provider account means an account opened in the provider equipment 21 or opened by the provider company. The provider account holder information memorized in the provider memory includes the information for identifying provider account holders, such as password, login name, name, address, telephone number, facsimile number, e-mail address, sex, date of birth, work field, family number, marriage status, and hobbies of the account holder. These information are usually registered in the provider memory when a person opens a provider account in the provider equipment 21. The provider point information is also memorized in connection with the provider point information code in connection with the provider account, as shown in FIGS. 6 and 7. The provider point information includes the information as to provider points, such as, available provider points, issued date of provider points. The provider controller 26 controls reading and rewriting the information in the provider memory 22 as described later.

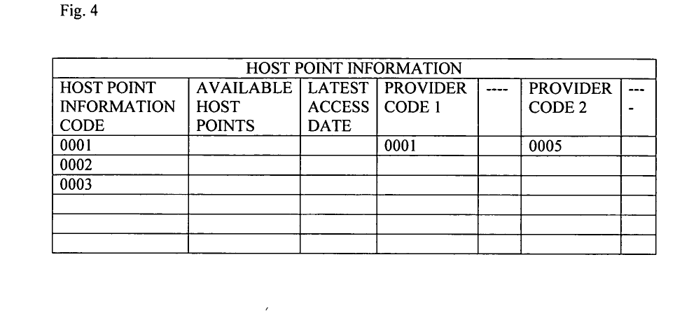

When a person having a provider account opens a host account, a provider code allotted to the provider is memorized to the host point information as shown in FIG. 4, so that the whole or part of the provider point information becomes readable or rewritable to the host equipment. The provider code is issued to a provider when the provider cooperates with the host company.

The system of the present invention has an account holder terminal 31 connected to the host equipment 11 via internet or telephone lines 2. In this invention, an account holder means a body to have a host account or provider account. The account holder terminal 31 is usually a personal computer, which is accessible to internet or telephone line to the host equipment. However, the account holder terminal does not limited thereto, so long as it can be accessible to internet or telephone. The account holder terminal 31 comprises at least a account holder memory 32, calculator (provider controller, CPU) 33, display 34, inputting device 35 and account holder controller 36. The display 34 of the account holder terminal 31 allows the account holder to browse the host point information including the available host points, and the provider point information including the available provider points, via internet or a telephone line 2. The account holder terminal also has the data inputting device 35 to designate a portion of the available provider points.

When the account holder checks his or her provider account on the account holder terminal 31, and wishes to exchange the available provider points into host points, the account holder designates the whole or a portion of the available provider points. Such designation is conducted on a designation page sent by the host equipment 11. After finishing to designate the whole or a portion of the available provider points, the account holder pushes a button to send the input data to the host equipment. In the host equipment 11, the available provider points sent by the account holder is received by the host equipment 11, exchanging them into host points at a current rate. The host points exchanged is added into the available host points and memorized in the host memory 12.

According to the present invention, the host controller 16 exchanges the provider points into the host points in accordance with a ratio determined in connection with a market principle. In this system 1, various providers participate in this system, and each of the providers issues a point whose market value is different from the others. Thus, to determine the rate is important in exchanging provider points into host points. For example, the ratio is determined upon taking consideration of an original rate, market ratio, and currency rate, and so on. The original rate is determined by how valuable a point of the provider originally is. Usually, the original rate is determined between the host company and a provider company. The original rate adjusts the difference among the kinds of points. Each provider issues points in various standards. The market rate is optionally determined, for example, by stock, bond rating rate, popularity and so on. The market rate adjusts the difference between the market values of the points. The market rate of a provider points is fluctuated by a market value. The market value may be in connection with a market evaluation of the provider. The currency rate is also applied if exchange is done between deferent currencies. If the exchange is done in the same currency, the currency rate is “1.”

For example, the ratio is determined by the following formula:
(the ratio)=A*B*C, where “A” represents an original rate, “B” represents a marketing rate, and “C” represents a currency rate. If the market rate is not applied, the market rate is “1,” in this formula. If the exchange is done in the same currency, the currency rate is “1.”

However, the present invention does not limit to the rate formula.

According to the present invention, the host points exchanged from the designated amount of the provider points are added into the available host points memorized in the host memory 12. On the other hand, the provider points designated and exchanged are subtracted from the available provider points memorized in the provider memory 22. According to the present invention, such the subtraction can be done directly by the host equipment, i.e., the host equipment directly rewrite the provider point information memorized in the provider memory 22. However, since it is considered that many providers do not wish to rewritten the content of the provider memory by an outside entity, the host equipment may inform the provider to suggest subtracting the whole or the portion of the available provider points which have already exchanged by the host equipment.

The host equipment 11 the present invention also have a function to reversely exchange the host points into the provider points.

The system of the present invention further includes a shopping equipment 41, as shown in FIG. 1. The shopping equipment 41 may be the same as or different from the provider equipment 21. That is, some of the providers sell articles or services, and upon selling the goods or services, provider points are deposited to the provider account of the customer. There may be a case where the articles or services provided by the provider are served as articles or services displayed by a shopping equipment 41. At the case, the provider equipment 21 is served as a shopping equipment.

The shopping equipment 41 displays articles and/or services. The account holder designates the article or service in exchange of the whole or a portion of the available host points. Conventionally, the points issued by a provider can be used only at a shop designated by the provider, limited to use the points only when reaching a specific amount. According to the present invention, the system allows a consumer to exchange various kinds of points into a standardized points, or host points, which are widely used in any aligning shopping equipments.

1. A system for exchanging a provider point information into a host point information, comprising:
(1) a host equipment, comprising
(i) a host memory for memorizing a host account in connection with a host account holder information and a host point information including available host points, and (ii) a host controller for controlling the host memory;
(2) a provider equipment connected to the host equipment, comprising:
(i) a provider memory for memorizing a provider account in connection with a provider account holder information and a provider point information including available provider points, and (ii) a provider controller for controlling the provider memory; and
(3) an account holder terminal connected to the host equipment, wherein the account holder terminal is provided to an account holder having the host account and the provider account, comprising:
(i) a display for browsing the host point information including the available host points, and the provider point information including the available provider points;
(ii) a data inputting device to designate a portion of the available provider points of the provider point information,
wherein the designated portion of the available provider points is sent to the host equipment and exchanged into host points in connection with the host point information, and wherein the host points exchanged are added into the available host points memorized in the host memory.

2. A system for exchanging a provider point information into a host point information according to claim 1, wherein the host controller exchanges the provider points into the host points in accordance with a ratio determined in connection with a market principle.

3. A system for exchanging a provider point information into a host point information according to claim 1, wherein the host controller exchanges the provider points into the host points in accordance with a ratio determined by the following formula: (the ratio)=A*B*C, where “A” represents an original rate, “B” represents a marketing rate, and “C” represents a currency rate.

4. A system for exchanging a provider point information into a host point information according to claim 1, wherein the host controller reversely exchanges the host points into the provider points.

5. A system for exchanging a provider point information into a host point information according to claim 1, wherein a portion of the available host points of the host point information is designated and exchanged into the provider points in connection with the provider point information, wherein the provider points exchanged is added into the available provider points memorized in the provider memory.

6. A system for exchanging a provider point information into a host point information according to claim 1, further including a shopping equipment displaying an article or service, wherein the account holder designates the article or service in exchange of a portion of the available host points.

7. A host equipment for exchanging a provider point information into a host point information, comprising:
(i) a host memory for memorizing a host account in connection with a host account holder information and a host point information including available host points, and (ii) a host controller for controlling the host memory;
wherein the host equipment is connected to a provider equipment, the provider equipment comprising
(i) a provider memory for memorizing a provider account in connection with a provider account holder information and a provider point information including available provider points, and (ii) a provider controller for controlling the provider memory;
wherein the host equipment is connected to an account holder terminal, the account holder terminal comprising:
(i) a display for browsing the host point information including the available host points, and the provider point information including the available provider points;
(ii) a data inputting device to designate a portion of the available provider points of the provider point information,
wherein the account holder terminal is provided to an account holder having the host account and the provider account, wherein the designated portion of the available provider points is sent to the host equipment and exchanged into host points in connection with the host point information, and wherein the host points exchanged are added into the available host points memorized in the host memory.

8. A host equipment for exchanging a provider point information into a host point information according to claim 7, wherein the host controller exchanges the provider points into the host points in accordance with a ratio determined in connection with a market principle.

9. A host equipment for exchanging a provider point information into a host point information according to claim 7, wherein the host controller exchanges the provider points into the host points in accordance with a ratio determined by the following formula: (the ratio)=A*B*C, where “A” represents an original rate, “B” represents a marketing rate, and “C” represents a currency rate.

10. A host equipment for exchanging a provider point information into a host point information according to claim 7, wherein the host controller reversely exchanges the host points into the provider points.

11. A host equipment for exchanging a provider point information into a host point information according to claim 7, wherein a portion of the available host points of the host point information is designated and exchanged into the provider points in connection with the provider point information, wherein the provider points exchanged is added into the available provider points memorized in the provider memory.

12. A host equipment for exchanging a provider point information into a host point information according to claim 7, further including a shopping equipment displaying an article or service, wherein the account holder designates the article or service in exchange of a portion of the available host points.

13. A provider equipment for exchanging a provider point information into a host point information, comprising:
a provider equipment connected to the host equipment, comprising:
(i) a provider memory for memorizing a provider account in connection with a provider account holder information and a provider point information including available provider points, and (ii) a provider controller for controlling the provider memory; and
wherein the provider equipment is connected to a host equipment, the host equipment comprising:
(i) a host memory for memorizing a host account in connection with a host account holder information and a host point information including available host points, and (ii) a host controller for controlling the host memory,
wherein the provider equipment is connected to an account holder terminal, the account holder terminal comprising:
(i) a display for browsing the host point information including the available host points, and the provider point information including the available provider points;
and (ii) a data inputting device to designate a portion of the available provider points of the provider point information,
wherein the account holder terminal is provided to an account holder having the host account and the provider account, wherein the designated portion of the available provider points is sent to the host controller of the host equipment and exchanged into host points in connection with the host point information, and wherein the host points exchanged are added into the available host points memorized in the host memory.

14. A provider equipment for exchanging a provider point information into a host point information according to claim 13, wherein the host controller exchanges the provider points into the host points in accordance with a ratio determined in connection with a market principle.

15. A provider equipment for exchanging a provider point information into a host point information according to claim 13, wherein the host controller exchanges the provider points into the host points in accordance with a ratio determined by the following formula: (the ratio)=A*B*C, where “A” represents an original rate, “B” represents a marketing rate, and “C” represents a currency rate.

16. A provider equipment for exchanging a provider point information into a host point information according to claim 13, wherein the host controller reversely exchanges the host points into the provider points.

17. A provider equipment for exchanging a provider point information into a host point information according to claim 13, wherein a portion of the available host points of the host point information is designated and exchanged into the provider points in connection with the provider point information, wherein the provider points exchanged is added into the available provider points memorized in the provider memory.

18. A provider equipment for exchanging a provider point information into a host point information according to claim 13, further including a shopping equipment displaying an article or service, wherein the account holder designates the article or service in exchange of a portion of the available host points.

19. An account holder terminal for exchanging a provider point information into a host point information, comprising:
(i) a display for browsing a host point information including available host points, and a provider point information including available provider points;(ii) a data inputting device to designate a portion of the available provider points of the provider point information,
wherein the account holder terminal is provided to an account holder having the host account and the provider account, comprising: wherein the account holder terminal is connected to a host equipment, the host equipment comprising:
(i) a host memory for memorizing a host account in connection with a host account holder information and a host point information including available host points, and (ii) a host controller for controlling the host memory,
wherein the account holder terminal is connected to a provider equipment connected to the host equipment, the provider equipment comprising:
(i) a provider memory for memorizing a provider account in connection with a provider account holder information and a provider point information including available provider points, and (ii) a provider controller for controlling the provider memory, and
wherein the designated portion of the available provider points is sent to the host equipment and exchanged into host points in connection with the host point information, and wherein the host points exchanged are added into the available host points memorized in the host memory.

20. An account holder terminal for exchanging a provider point information into a host point information according to claim 19, wherein the host controller exchanges the provider points into the host points in accordance with a ratio determined in connection with a market principle.

21. An account holder terminal for exchanging a provider point information into a host point information according to claim 19, wherein the host controller exchanges the provider points into the host points in accordance with a ratio determined by the following formula: (the ratio)=A*B*C, where “A” represents an original rate, “B” represents a marketing rate, and “C” represents a currency rate.

22. An account holder terminal for exchanging a provider point information into a host point information according to claim 19, wherein the host controller reversely exchanges the host points into the provider points.

23. An account holder terminal for exchanging a provider point information into a host point information according to claim 19, wherein a portion of the available host points of the host point information is designated and exchanged into the provider points in connection with the provider point information, wherein the provider points exchanged is added into the available provider points memorized in the provider memory.

24. An account holder terminal for exchanging a provider point information into a host point information according to claim 19, further including a shopping equipment displaying an article or service, wherein the account holder designates the article or service in exchange of a portion of the available host points.
